(19) United States
(12) Patent Application Publication
(10) Pub. No.: US 2025/0069214 A1
(43) Pub. Date: Feb. 27, 2025

(54) AUTOMATED CHARACTERIZATION OF MATERIAL DEFECTS IN PAVED SURFACES

(71) Applicants: Robert C. Moate, Auburn, WA (US); Tyler Jordan Harris, Edgewood, WA (US)

(72) Inventors: Robert C. Moate, Auburn, WA (US); Tyler Jordan Harris, Edgewood, WA (US)

(21) Appl. No.: 18/454,723

(22) Filed: Aug. 23, 2023

(51) Int. Cl. G06T 7/00; G06T 7/11

(52) U.S. Cl. CPC G06T 7/001; G06T 7/11; G06T 2207/10024; G06T 2207/20081

(57) ABSTRACT

Aspects of the present application relate to the automated characterization of material defects in paved surfaces. More specifically, in accordance with one or more aspects of the present application, a location processing service may be utilized to utilized machine-learned algorithms in the characterization of material defects in paved surfaces. The characterizations are illustratively associated with a hierarchical set of categories. The location processing service can further utilize machine learned algorithms to identify one or more remediation recommendations corresponding to the associated characterization of the paved surface.

### BACKGROUND

Generally described, computing devices can utilize communication networks to exchange data. Companies and organizations operate computer networks that interconnect a number of computing devices to support operations or provide services to third parties. The computing systems can be located in a single geographic location or located in multiple, distinct geographic locations (e.g., interconnected via private or public communication networks). Specifically, hosted computing environments or data processing centers, generally referred to herein as “data centers,” may include a number of interconnected computing systems to provide computing resources to users of the data center. The data centers may be private data centers operated on behalf of an organization or public data centers operated on behalf of, or for the benefit of, the general public.

In general, network-based computing is an approach to providing access to information technology resources through services such as network-based services. For example, network services can be utilized to process information provided by computing devices such processing image data. Additionally, in some embodiments, computing devices can be utilized to provide control instructions to other devices.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 depicts a block diagram of a system for providing characterizations of material defects in paved surfaces in which various embodiments, according to the present disclosure, can be implemented.

FIG. 2A is an illustrative architecture of a computing device associated with an image capture device in accordance with various embodiments of the present application.

FIG. 2B is an illustrative architecture of a computing device associated with a location image processing service in accordance with various embodiments of the present application.

FIG. 3A is a block diagram of the system of FIG. 1 illustrating interaction of the location image processing service and devices in a geographic location.

FIG. 3B is a block diagram of the system of FIG. 1 illustrating interaction of the location image processing service and devices in a geographic location.

FIG. 4 is a flow diagram illustrative of an image capture configuration routine in accordance with illustrative aspects of the present application.

FIG. 5 is a flow diagram illustrative of an image processing routine in accordance with illustrative aspects of the present application.

FIGS. 6A-6C are block diagrams illustrating the identification of flight paths/patterns and sub-regions for geofencing in accordance with illustrative aspects of the present disclosure.

### DETAILED DESCRIPTION

In the following description, various examples will be described. For purposes of explanation, specific configurations, and details are set forth in order to provide a thorough understanding of the examples. However, it will also be apparent to one skilled in the art that the examples may be practiced without specific details. Furthermore, well-known features may be omitted or simplified in order not to obscure the examples being described.

Generally described, aspects of the present application relate to the automated characterization of material defects in paved surfaces. Generally described, paved surfaces, such as parking lots, may suffer from material defects, failures, faults, etc. Indicators of different types and degrees of faults can include, but are not limited to, changes in porosity of the paved materials, types and degrees of cracking, depression in the surface, holes in the surfaces, and the like. In accordance with one or more aspects of the present application, a location processing service may be utilized to utilized machine-learned algorithms in the characterization of material defects in paved surfaces. The characterizations are illustratively associated with a hierarchical set of categories. The location processing service can further utilize machine learned algorithms to identify one or more remediation recommendations corresponding to the associated characterization of the paved surface.

In accordance with illustrative embodiments, the inputs to the machine learned algorithms can correspond to sensor data, illustratively corresponding to image data, collected from an image capture device, such as a drone. To facilitate the capture of image data, a region of interest, such as a parking lot or other paved surface, is identified. The region of interest is then associated with geofencing information that defines one or more boundaries that will be included in the characterization. The boundaries can include outer boundaries of the region of interest, excluded areas, areas of increased interest, and the like.

Using the geofencing information, the location image processing service can also determine flight path/pattern information that facilitates that drone (or other image capture device) to traverse the geographic region and capture image data. Illustratively, the drone can be configured with image capture configuration information that facilitates the capture of a set of image data for plurality of sub-regions. The sub-regions can represent an ordered set of areas with the region that will be each associated with image data. For example, a sub-region can correspond to a geometric block/square of a fixed dimension (5 ft. by 5 ft.).

Using the geofencing information, flight path/pattern information and image capture configuration information, the location processing service, through a local controller, can cause the drone to capture image data. For example, the drone can capture top-down perspective images of each sub-region as well as angled images of preceding or subsequent sub-regions. The resulting set of image data may be transmitted to the location processing service.

Upon receipt of collected image data, the location image processing service can process the set of image data, which can include a plurality of image data for each individual sub-region, such as a texture map, grayscale image, color image and the like. The location image processing service can also implement various extrapolations, image combination, error correction, to modify the originally collected images. In some embodiments, the location image processing service may also update the flight pattern or image capture configuration information in the event that additional images may be required due to poor quality or a need to for more detailed imagery (e.g., a more detailed set of images for a potential material defect).

For each individual sub-region, the location image processing service can then apply one or more machine learned algorithms in which the processing image data is used as inputs. Additional inputs may also be applied. The machine learned algorithms may be configured to then generate a characterization of material defects that may be depicted in the image data. Illustratively, the characterization of material defects can correspond to hierarchical categories progressing from no significant material defects (e.g., no remediation required) to most significant material defects (e.g., complete replacement required). By way of illustrative example, the hierarchical categories can be associated with six characterizations such that each categories relates specific processing of identifiable traits or attributes that can be captured in the set of image data. Illustratively, the training sets used to train the machine-learned algorithms, such as in a supervised learning algorithm, can be selected for purposes of distinguishing between the different hierarchical categories based on the input data, including the set of image data per sub-region.

In addition to the characterization of the sub-regions, the location image processing service can further provide remediation recommendations based on, or as a function, of the characterization and image data. Illustratively, the remediation recommendations can include an identification of various remediation techniques (e.g., application of sealer, application of patching materials, partial replacement of paved materials, complete replacement of the paved materials, etc.). The remediation recommendations can further include estimates of materials required for remediation, such as volumes/weight of materials, financial costs for the estimated volumes/weights, application times (e.g., preparation and curing times), scheduling workflows, and the like. Accordingly, an individual remediation recommendation can be provided for each sub-region.

Additionally, in some embodiments, the location image processing service can further aggregate the remediation recommendations for individual sub-regions for a plurality of sub-regions. For example, the location image processing service can apply thresholds to a set of remediation recommendations for individual sub-regions (e.g., patching of cracks) and determine if an escalated remediation for a plurality of sub-regions (e.g., partial or full replacement) will be provided. Still further, the location image processing service can be further configured to provide or conduct additional analysis, such as compliance with regulatory requirements (e.g., American with Disabilities (ADA) regulations) for markings, signage, etc., analysis of striping/marking for parking stalls, identification of organic materials embedded in the paved materials, structural integrity of related components/structures (e.g., curbs, railings, etc.) and the like. The additional processing can further include detailed information and planning for various inventory, budgetary, and scheduling systems and services. The recommendations and characterizations may be illustratively provided as processing results, such as for user interfaces, ordering systems, project management software, and the like.

Traditional approaches to surveying and assessing material defects for paved surfaces, such as parking lots, corresponds to manual one more manual processes implemented by humans. For example, a human may traverse a paved area and make manual notes or measurements of potential defects in paved surfaces. In this regard, the human must solely rely on the information provided by eyesight, e.g., a single perspective. Additionally, manual human processes, such as inspection is not well suited for associating the analysis according to sub-regions of paved surface without significant additional effort time. Additionally, manual processes involving a set of humans traversing a paved areas and making individual assessments are vulnerable to inconsistencies in terms of information collection and assessments.

The use of image capture devices to survey different types of terrain have been implemented for different applications, such as identifying weather conditions, surveying areas for construction planning, etc. Such approaches do not incorporate machine learned algorithms for characterizing paved services according to a hierarchical based approach. Accordingly, even if traditional image capture methodologies would be applied to identifying material defects in paved surfaces, such approaches would also share the same inefficiencies and variances associated with manual processes. Still further, traditional systems do not further include or integrate various additional processing functionality, such as integration with budgeting tools and services, inventory or ordering tools and services, scheduling tools and services, and the like.

Although aspects of the present disclosure will be described with regard to illustrative network components, interactions, and routines, one skilled in the relevant art will appreciate that one or more aspects of the present disclosure may be implemented in accordance with various environments, system architectures, customer computing device architectures, and the like. Similarly, references to specific devices, such as a control computing device, can be considered to be general references and not intended to provide additional meaning or configurations for individual customer computing devices. Additionally, the examples are intended to be illustrative in nature and should not be construed as limiting.

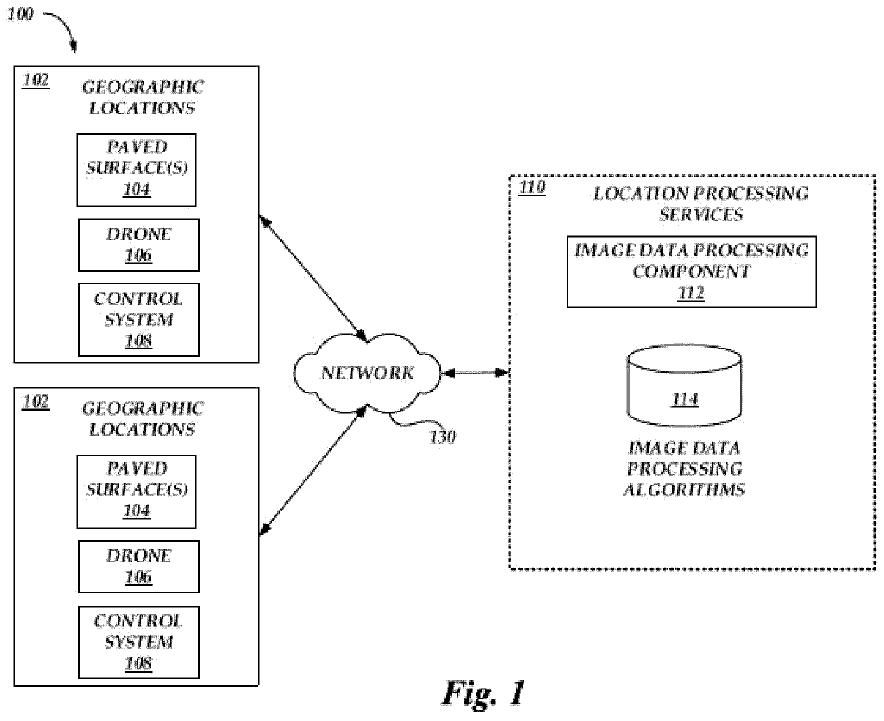

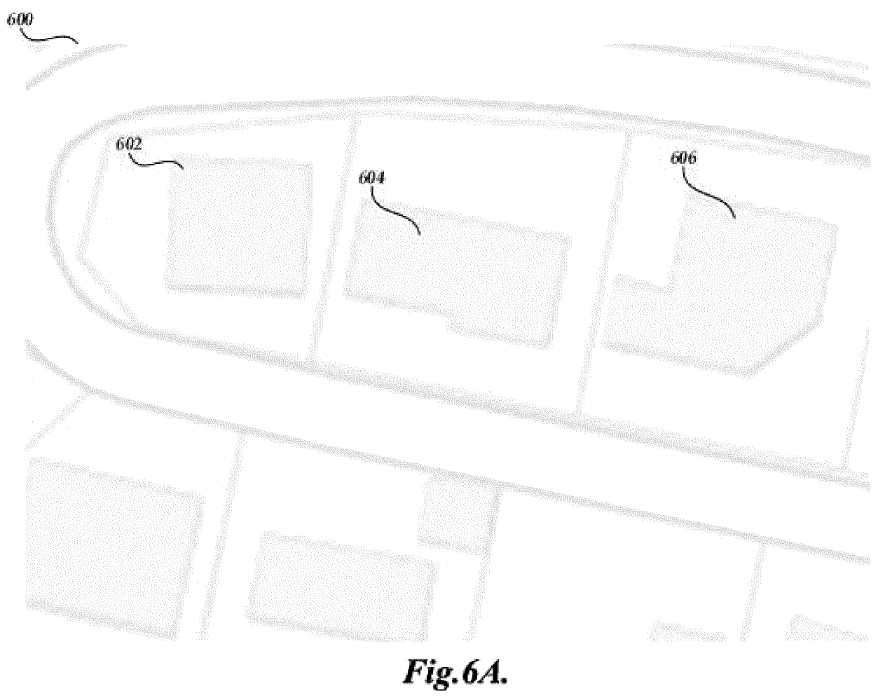

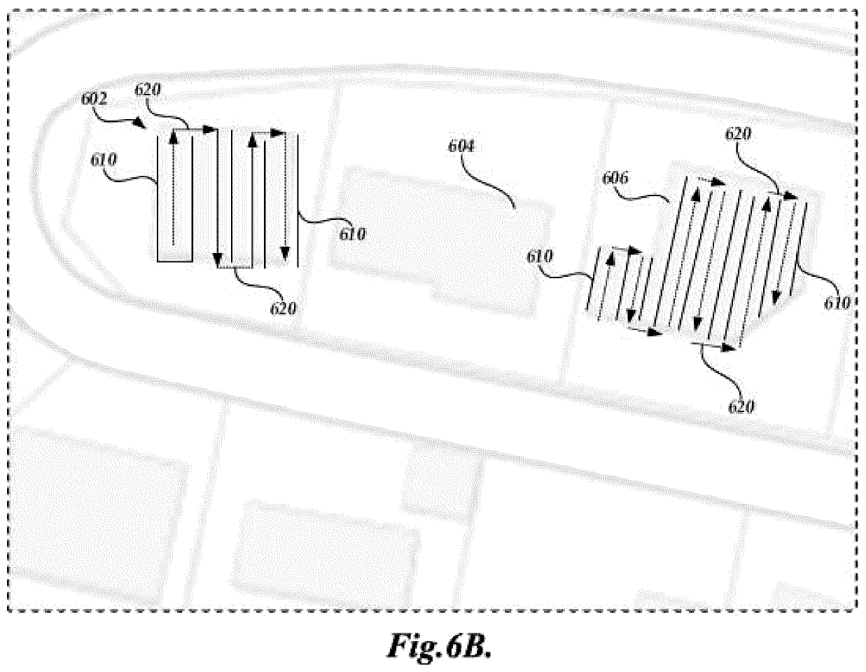

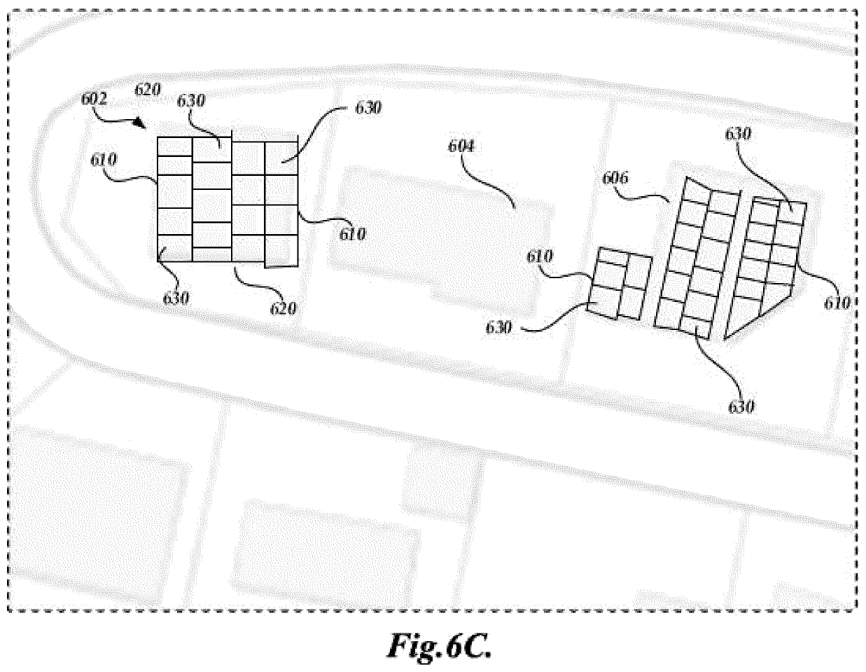

With reference to FIG. 1, an illustrative system or environment 100 for characterizing material defects in paved surfaces will be described. The system includes a plurality of geographic locations 102, which include one or more paved surfaces 104 for analysis. Illustratively, the paved surfaces 104 can include parking lots, sidewalks, parking garage surfaces, driveways, and the like. For purposes of illustration, FIG. 6A represents a geographic location 102 having three distinct paved surfaces 602, 604, 606 that can be defined according to geofencing and processed as described. FIGS. 6A-6C will be utilized in according to the illustrative examples herein. Returning to FIG. 1, in some embodiments, the geographic location 102 may include multiple paved surfaces, each of which may be individually processed as described herein. Additionally, as illustrated in FIG. 1, the system 100 may include multiple geographic locations 102 that are independent and can be subject to separate characterizations, remediation recommendations or other processing described herein. Although various illustrative examples will be described with regard to parking lots as exemplary of the paved surfaces 104, one skilled in the relevant art will appreciate that scope of the present application should not be construed in a manner to limit applicability to parking lots in particular.

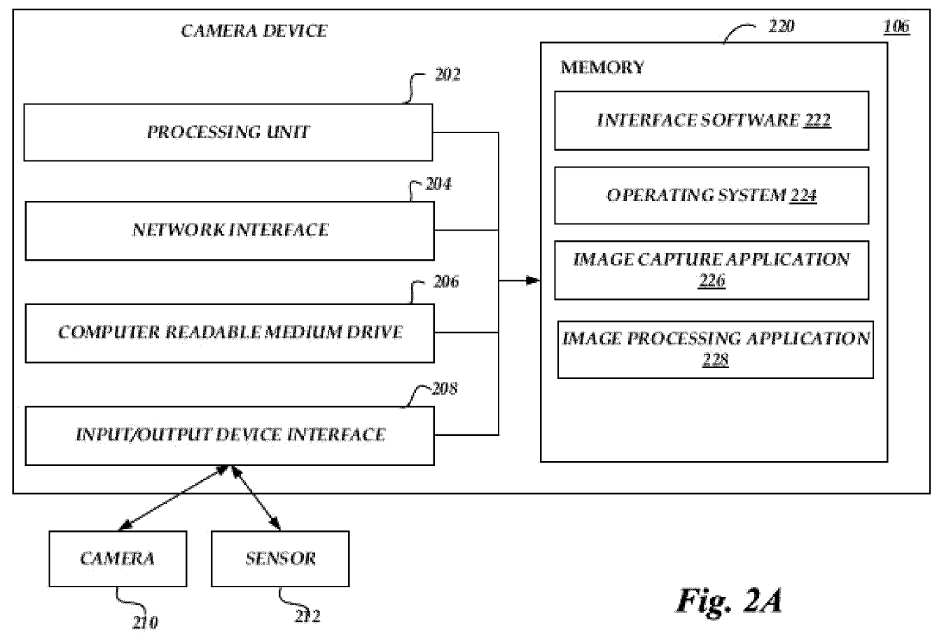

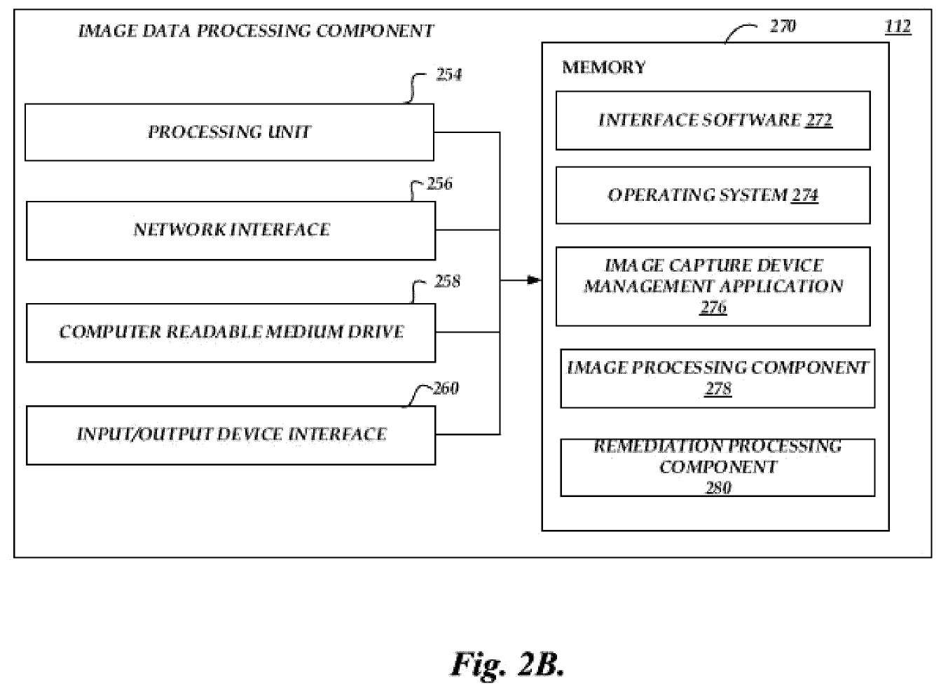

Illustratively, each individual geographic location 102 may be associated with an image capture device 106 and control system 108 that facilitate the traversal of a flight plan associated with geofencing information and capture of a set of images as described herein. The image capture device 106 may be generally referred to as a drone and corresponds to a class of devices (commercial or consumer) that are capable for controlled flight and sensor information capture (e.g., image capture) via control instructions transmitted by the control system 108, such as via radio frequency-based communications. An illustrative architecture of an image capture device 106 will be described in FIG. 2A, but one skilled in the relevant art will appreciate that various configurations and implementations of image capture devices 106 and control systems 108 may be utilized in accordance with aspects of the present application. Additionally, although the image capture device 106 and control system 108 are shown as associated with a geographic location 102, the image capture device and control system do not form part of the geographic area but are provided (at least temporarily) in physical proximity to capture image data as described herein. Although reference will be provided to image capture device 106, various configurations of devices to capture sensor data will be described and should be considered to be within the scope of the present application.

With continued reference to FIG. 1, the location processing service 110 corresponds to a logical association of one or more services to configure the operation of the image capture device 106, processing a set of captured image data and generate processing results corresponding to a machine learned processing of captured image data. For example, the location processing service 110 can include an image data processing component 112 (image data processing components) for implementing the various functionality described herein and associated with the location processing service 110. An illustrative architecture for the image data processing component 112 will be described with regard to FIG. 2B. The location processing service 110 further includes a data store 114 for maintaining image data processing algorithms. Illustratively the image data processing algorithms can correspond to machine learned algorithms configured to process a set of inputs, including image data, and generating processing results corresponding to characterizations of material defects in paved surfaces according to hierarchical categories. Although illustrated as part of the location processing service 110 the image data processing algorithms in the data store 114 may be maintained and implemented/executed by additional service providers, such as a third-party provider. Accordingly, the location processing service 110 depicted in FIG. 1 should be considered to be logically represented.

In some embodiments, the network 130 may include one or more wireless networks, such as a Global System for Mobile Communications (GSM) network, a Code Division Multiple Access (CDMA) network, a Long Term Evolution (LTE) network, or any other type of wireless network. The network 130 can use protocols and components for communicating via the Internet or any of the other aforementioned types of networks. For example, the protocols used by the network 130 may include Hypertext Transfer Protocol (HTTP), HTTP Secure (HTTPS), Message Queue Telemetry Transport (MQTT), Constrained Application Protocol (CoAP), and the like. Protocols and components for communicating via the internet or any of the other aforementioned types of communication networks are well known to those skilled in the art and, thus, are not described in more detail herein. In some embodiments, the network 130 may include some or all of the same communication protocols, services, hardware, etc. Thus, although the discussion herein may describe communication between the local processing component 110, drones 106 and control components 109 via the network 130 is not limited in this manner. The various communication protocols discussed herein are merely examples, and the present application is not limited thereto.

FIG. 2A depicts one embodiment of an architecture of an image capture device 106. The image capture device 106 can be configured to traverse an identified region defined according to geofencing information and a flight plan/pattern. Additionally, the image capture device 106 can further be configured to capture sensor data for the identified region according to configuration information. Illustratively, the image capture device 106 will be described with regard to capturing image data from the identified region. Such capture image data includes, but is not limited to, types of images, number of images, angles/perspectives of image captures, attributes of image capture (e.g., pixels, exposures), and the like.

The general architecture of the image capture device 106 depicted in FIG. 2A includes an arrangement of computer hardware and software components that may be used to implement aspects of the present disclosure. As illustrated, the image capture device 106 includes a processing unit 202, a network interface 204, a computer-readable medium drive 206, and an input/output device interface 208, all of which may communicate with one another by way of a communication bus. The input/output device interface 208 may further be associated with various components such as one or more cameras 210 and additional sensors 212 (such as infrared sensors, LIDAR sensors, SONAR sensors, RADAR sensors, etc.). Reference to the capture of sensor data in illustratively embodiments, can include capture of image data, capture of non-image data, or a combination thereof.

The network interface 204 may provide connectivity to one or more networks or computing systems, such as the network 130 of FIG. 1. The processing unit 202 may thus receive information and instructions from other computing systems or services via a network. The processing unit 202 may also communicate to and from memory 220. In some embodiments, the localization service 122 may include more (or fewer) components than those shown in FIG. 2A.

The memory 220 may include computer program instructions that the processing unit 202 executes in order to implement one or more embodiments. The memory 220 generally includes RAM, ROM, or other persistent or non-transitory memory. The memory 220 may store an operating system 224 that provides computer program instructions for use by the processing unit 202 in the general administration and operation of the image capture device 106. The memory 220 may further include computer program instructions and other information for implementing aspects of the present disclosure when executed by the processing unit 202. For example, in one embodiment, the memory 220 includes interface software 222 for communicating with other components or services.

The memory 220 may also include an image capture application 226 for receiving and processing image capture confirmation information. Illustratively, the image capture configuration information can illustratively specify sub-regions within a geofence, image selection criteria, image capture attributes, etc. The memory 220 may also include an image processing application 228 that can be optionally used by the image capture device 106 for the generation of a set of images for individual sub-regions (e.g., creating texture maps, error correction, etc.). Although not illustrated, the image capture device 106 can further include additional applications/components for use in the control of the image capture device, such as control applications for executing an established flight path/pattern.

FIG. 2B depicts one embodiment of an architecture of an image data processing component 112. As described above, the image data processing component 112 can be configured for implementing the various functionality described herein and associated with the location processing service 110. Specifically, the image data processing component 112 can configured to implement one or more services to configure the operation of the image capture device 106, processing a set of captured image data and generate processing results corresponding to a machine learned processing of captured image data. For example, the location processing service 110 can include an image data processing component 112 (image data processing components).

The general architecture of the image data processing component 112 depicted in FIG. 2B includes an arrangement of computer hardware and software components that may be used to implement aspects of the present disclosure. As illustrated, the image data processing component 112 includes a processing unit 254, a network interface 256, a computer-readable medium drive 258, and an input/output device interface 260, all of which may communicate with one another by way of a communication bus. The image data processing component 112 may be physical hardware components or implemented in a virtualized environment.

The network interface 256 may provide connectivity to one or more networks or computing systems, such as the network 130 of FIG. 1. The processing unit 254 may thus receive information and instructions from other computing systems or services via a network. The processing unit 254 may also communicate to and from memory 270 and further provide output information via the input/output device interface 260. In some embodiments, the image data processing component 112 may include more (or fewer) components than those shown in FIG. 2B.

The memory 270 may include computer program instructions that the processing unit 254 executes in order to implement one or more embodiments. The memory 270 generally includes RAM, ROM, or other persistent or non-transitory memory. The memory 270 may store an operating system 274 that provides computer program instructions for use by the processing unit 254 in the general administration and operation of the image data processing component 112. The memory 270 may further include computer program instructions and other information for implementing aspects of the present disclosure. For example, in one embodiment, the memory 270 includes interface software 272 for communicating with other components or services.

The memory 270 may include an image capture device management application 276 for defining geofencing information, determining flight plan/pattern information based on geofencing information and identifying updates to the flight plan/pattern information. Additionally, the image capture device management application 276 can further determine or identify image capture configuration information such as definitions of sub-regions in a geofence, image types, image attributes, and the like. The memory 270 may further include an image processing component 278 for processing a collected set of images, including error correction, extrapolation, additional image correction, and the like. The image processing component can further execute (or cause to be executed) machine learned algorithms using a set of image data to generate outputs corresponding to a characterization of sub-regions according to hierarchical categories. The memory 270 can further include a remediation processing component 280 for generating remediation recommendations for individual sub-regions and a plurality of sub-regions. The remediation processing component 280 may further execute (or cause to be executed) machine learned algorithms for generating outputs corresponding to remediation techniques and additional estimates.

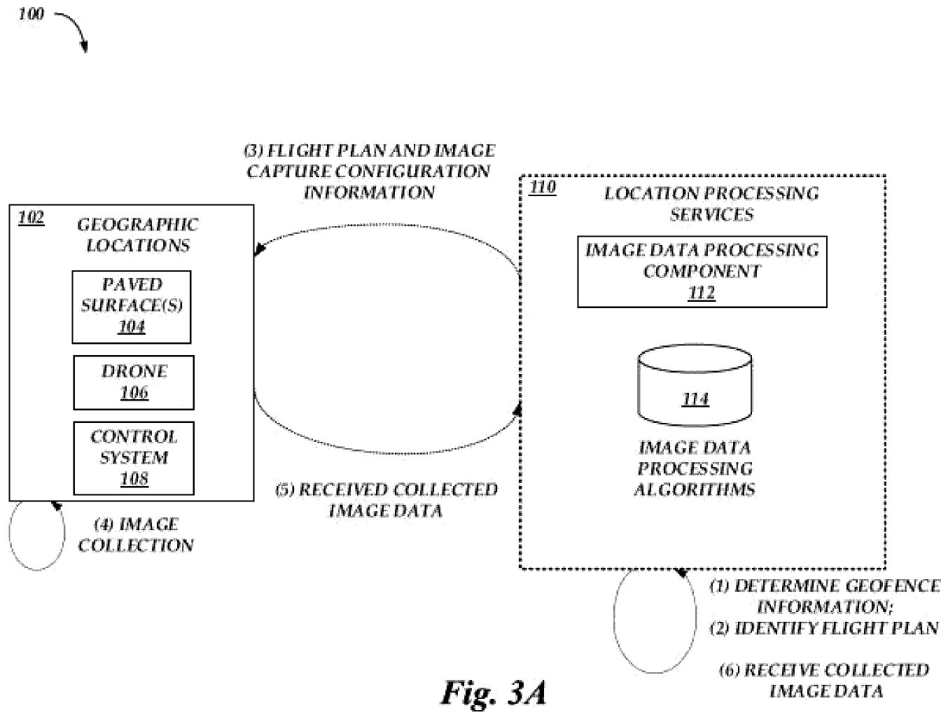

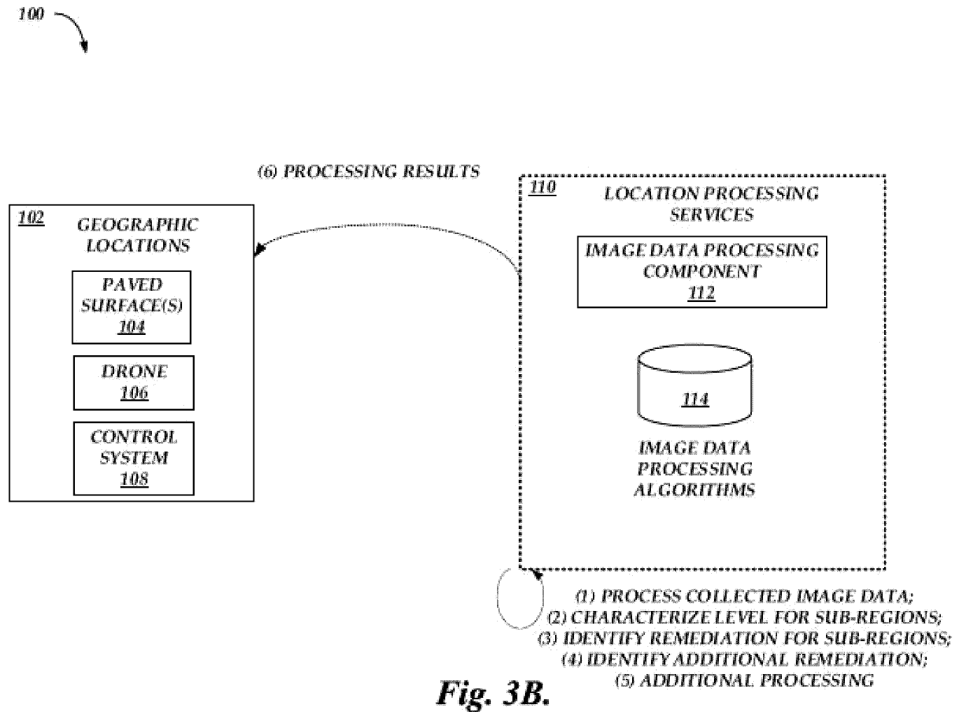

Turning now to FIGS. 3A and 3B, illustrative interactions of the components of the system of FIG. 1 will be described. With reference to FIG. 3A, to facilitate the capture of image data, a region of interest, such as a parking lot or other paved surface, is identified. At (1), the location processing service associates areas of interest with geofencing information that defines one or more boundaries that will be included in the characterization. The boundaries can include outer boundaries of the region of interest, excluded areas, areas of increased interest, and the like. With reference to the previous example of FIG. 6A having three potential paved surfaces 602, 604, 606, in one example, assume region 602 and 606 will be processed for characterization of material defects in the paved surfaces. As illustrated in FIG. 6B, geofencing information 610 can be defined for each paved surface 602, 606 according to the areas that will be subject to image capture and analysis.

Returning to FIG. 3A, using the geofencing information, at (2) the location processing service 110 can also determine flight path/pattern information that facilitates that drone (or other image capture device) to traverse the geographic region and capture image data. With reference to FIG. 6B, each of the regions to be processed 602, 660 are further associated with flight path/flight pattern information 620 that defines a traversal path for the image capture device 106. The flight pattern/path information may be formatted and encoded in accordance with specific requirement associated with individual image capture device.

Additionally, the drone can be configured with image capture configuration information that facilitates the capture of a set of image data for plurality of sub-regions. The sub-regions can represent an ordered set of areas with the region that will be each associated with image data. For example, a sub-region can correspond to a geometric block/square of a fixed dimension (5 ft. by 5 ft.). With reference now to FIG. 6C, each region of interest 602, 606 is further associated with a plurality of sub-region data 630 that can represent individual portions that will be minimum area for image capture by the image capture device 106. In some embodiments, the sub-regions 630 do not need to uniform in nature and may conform to the specific contours of the paved area. Additionally, the sub-regions 630 may be based on limitations or other requirements of the image capture device (e.g., zoom capabilities). Furthermore, as illustrated in region 606, some portion of paved area may be excluded from image capture or analysis or may correspond to unpaved portions of a geographic area.

Returning to FIG. 3A, at (3), using the geofencing information, flight path/pattern information and image capture configuration information, the location processing service, through a local controller, can transmit configuration information and cause the drone to capture image data at (4). For example, the drone can progress according to the flight plan information and capture top-down perspective images of each sub-region (e.g., 630 of FIG. 6C) as well as angled images of preceding or subsequent sub-regions. The resulting set of image data may be transmitted to the location processing service 110 at (5) and stored by the location processing service at (6).

Turning now to FIG. 3B, upon receipt of collected image data, the location processing service 110 can process the set of image data at (1), which can include a plurality of image data for each individual sub-region, such as a texture map, grayscale image, color image and the like. The location processing service can also implement various extrapolations, image combination, error correction, to modify the originally collected images. In some embodiments, the location processing service may also update the flight pattern or image capture configuration information in the event that additional images may be required due to poor quality or a need to for more detailed imagery (e.g., a more detailed set of images for a potential material defect).

At (2), for each individual sub-region, the location processing service 110 can then apply one or more machine learned algorithms in which the processing image data is used as inputs. Additional inputs may also be applied. The machine learned algorithms may be configured to then generate a characterization of material defects that may be depicted in the image data. Illustratively, the characterization of material defects can correspond to hierarchical categories progressing from no significant material defects (e.g., no remediation required) to most significant material defects (e.g., complete replacement required).

By way of illustrative example, the hierarchical categories can be associated with six characterizations such that each categories relates specific processing of identifiable traits or attributes that can be captured in the set of image data. Table 1 illustrates a sample hierarchy of categories for material defects for paved surfaces identifying some indicators for potential categorizations of material defects in paved surfaces. Illustratively, the indicators are not typically binary in nature (e.g., a determination of presence or not presence). Rather in some embodiments, at least some of the indicators require additional processing to determine attributes of determined indicators such as estimation of porosity, crack types and attributes, and the like.

TABLE 1

| Category Type | Indicators | Remediation |
|---|---|---|
| Category 0 | Determination of porosity for the sub- | No immediate remediation |
| | region; No threshold amounts of | recommendations. |
| | porosity; No threshold cracks | |
| Category 1 | Determination of porosity for the sub- | Application of coating/sealer to |
| | region; Threshold amounts of porosity | replace the wear layer of the sub- |
| | exceeded; No threshold cracks | region. |
| Category 2 | Identification of singular cracks | Clean identified cracks; Apply |
| | exceeding threshold amounts | filler material to fill cracks |
| | (individually or cumulatively) | |
| Category 3 | Block cracking - spider web shaped or | Apply patching material to region |
| | alligator shaped cracks; Determine | of block cracking; Remove and |
| | percentage of sub-region attributable | replace areas within sub-region |
| | to block cracking; | with block cracks |
| Category 4 | Determine percentage of sub-region | Partial replacement of region. If |
| | attributable to block cracking; | percentage of sub-region exceeds |
| | Excessive block cracking above | threshold, overlay entire sub- |
| | threshold (e.g., major block cracking) | region |
| Category 5 | Depressions; crumbling; open spaces. | Removal of asphalt material; |
| | Determination of asphalt failure with | Remove and replace substrate; |
| | sub-grade destabilization. | Replace asphalt |

Illustratively, the training sets used to train the machine-learned algorithms, such as in a supervised learning algorithm, can be selected for purposes of distinguishing between the different hierarchical categories based on the input data, including the set of image data per sub-region. In some embodiments, a single machine learned algorithm may be configured with training sets that identify potential material defects in paved services (e.g., cracks, sunken material, porosity, sub-grade destabilization, asphalt failure, etc.) and can further characterize differences in severity. For example, machine learned algorithms may be configured to determine ratio of the volume of voids in the sub-regions or pore space divided by the total volume based on image data (e.g., porosity). In another example, machine learned algorithms may be able to identify cracks formed in the paved surface of a sub-region and attributes of the crack including length, patterns, etc. The machine learned algorithms can further be configured to then generate the characterizations of the severity of the material defects. In other embodiments, a plurality of machine learned algorithms may be configured to determine assets regarding individual categories (or groupings of categories) and associated confidence values in the characterizations.

In addition to the characterization of the sub-regions, at (3) the location processing service 110 can further provide remediation recommendations based on, or as a function, of the characterization and image data. Illustratively, the remediation recommendations can include an identification of various remediation techniques (e.g., application of scaler, application of patching materials, partial replacement of paved materials, complete replacement of the paved materials, etc.). The remediation recommendations can further include estimates of materials required for remediation, such as volumes/weight of materials, financial costs for the estimated volumes/weights, application times (e.g., preparation and curing times), scheduling constraints, and the like. Accordingly, an individual remediation recommendation can be provided for each sub-region.

As described above, in some embodiments, at (4), the location processing service 110 can further aggregate the remediation recommendations for individual sub-regions for a plurality of sub-regions. For example, the location image processing service can apply thresholds to a number of remediation recommendations (e.g., patching of cracks) and determine if an escalated remediation for a plurality of sub-regions (e.g., partial or full replacement) will be provided. Still further, at (5) the location image processing service can be further configured to provide additional analysis, such as compliance with regulatory requirements, such as American with Disabilities (ADA) regulations for markings, signage, etc. The additional analysis can include a review of existing markings or signage and recommendations for additions, substitutions, modifications, etc. For example, the additional analysis can include analysis related to striping of the paved surface, such as for parking stalls, directional markers, and the like. Other types of analysis can include identifying organic growth in defects (e.g., moss, tree roots, etc.), trip hazards, drain conditions, curb condition, and the like. Additionally, the location processing service 110 can utilize additional information provided from external resources, such as inventory systems, crew availability, environmental information, etc. to adjust or update remediation recommendations. The additional information may be illustratively accessed via interfaces or other data structures provide via the network 130. The recommendations and characterizations may be illustratively provided as processing results, such as for user interfaces, ordering systems, project management software, and the like at (6).

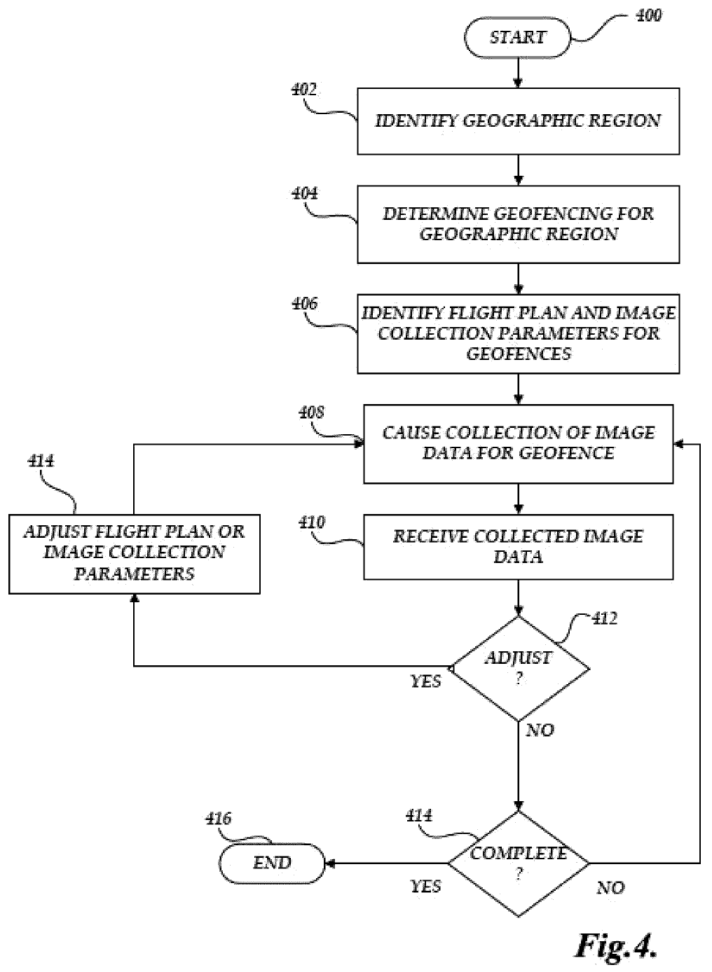

Turning now to FIG. 4, a routine 400 implemented by the location processing service 110 for configuring the capture of image data will be described. At block 402, the location processing service 110 associates areas of interest for capturing image data and block 404 identifies geofencing information that defines one or more boundaries that will be included in the characterization. The boundaries can include outer boundaries of the region of interest, excluded areas, areas of increased interest, and the like. With reference to the previous example of FIG. 6A having three potential paved surfaces 602, 604, 606, in one example, assume region 602 and 606 will be processed for characterization of material defects in the paved surfaces. As illustrated in FIG. 6B, geofencing information 610 can be defined for each paved surface 602, 606 according to the areas that will be subject to image capture and analysis. Illustratively, the identification of the region of interest and geofencing information may be provide by the control system 108 by local user, or via interfaces supported by the location processing service 110.

Returning to FIG. 4, using the geofencing information, at block 406, the location processing service 110 can also determine flight path/pattern information that facilitates that drone (or other image capture device) to traverse the geographic region and capture image data. As previously described in FIG. 6B, each of the regions to be processed 602, 660 are further associated with flight path/flight pattern information 620 that defines a traversal path for the image capture device 106. The flight pattern/path information may be formatted and encoded in accordance with specific requirement associated with individual image capture device. In some embodiments, the location processing service 110 can interact with the local control system 108 or other interfaces to identify, modify or supplement flight plan information. Still further, in some embodiments, the determination of flight path/pattern information may be automatically determined according to control system 108 functionality provided for the individual image capture device 106 and additional flight path/pattern information may not need to be generated. In some embodiments, the flight paths may be configured so as to capture individual images for sub-regions with no overlapping traversals or images. In other embodiments, the flight paths may be specifically configured to have overlapping flight patterns so that image capture device 106 can specifically capture multiple images or multiple angles of individual sub-regions.

Additionally, at block 406, the image capture device 106 can be configured with image capture configuration information that facilitates the capture of a set of image data for plurality of sub-regions. The sub-regions can represent an ordered set of areas with the region that will be each associated with image data. For example, FIG. 6C illustrates that each region of interest 602, 606 is further associated with a plurality of sub-region data 630 that can represent individual portions that will be minimum area for image capture by the image capture device 106. In some embodiments, the sub-regions 630 do not need to uniform in nature and may conform to the specific contours of the paved area. Additionally, the sub-regions 630 may be based on limitations or other requirements of the image capture device (e.g., zoom capabilities). Furthermore, as illustrated in region 606, some portion of paved area may be excluded from image capture or analysis or may correspond to unpaved portions of a geographic area.

Returning to FIG. 4, at block 408, using the geofencing information, flight path/pattern information and image capture configuration information, the location processing service, through a local controller, can transmit configuration information and cause the image capture device 106 to capture sensor data, illustratively discussed with regard to image data. For example, the drone can progress according to the flight plan information and capture top-down perspective images of each sub-region (e.g., 630 of FIG. 6C) as well as angled images of preceding or subsequent sub-regions. Specifically, in some embodiment, the image capture device 106 may include or configure an image capture device to take a substantially “top down” image of each sub-region as well as angled images of preceding or subsequent sub-regions so that each sub-region can be associated with a set of image data from different angles. Illustratively, the image capture device 106 can add meta-data to individual captured image data, such as geographic coordinates, sequence numbers, atmospheric conditions (e.g., degree of light, presence of moisture, etc.) to the individual images. The meta-data may be utilized as part of the inputs to the machine learned algorithm.

In some embodiments, the location processing service 110 can implement a feedback loop to allow the image capture device 106 to capture additional images. For example, the location processing service 110 can cause the image capture device 106 to recapture images based on error rates in the original captured image, errors in processing captured images, environmental impacts, and the like. In another example, the location processing service 110 can further cause additional images based on processing of originally capture images and object depicted in the images, including additional imagery related to cracks, porosity measurements, and the like. Accordingly, at decision block 412, the location processing service 110 makes a determination of whether to adjust the flight pattern/path to allow for additional imagery to be captured. If so, at block 414, the location processing service 110 can adjust the flight path, image capture configuration data, or other relevant information to cause the image capture device 106 to capture the additional imagery. The routine 400 can return to block 408 to execute the adjustment.

If no adjustment is needed or once the adjustment has been implemented, at block 414, the location processing service 110 makes a determination whether additional geofences or areas of traversal are required to be traversed. For example, as illustrated in FIG. 6C, specific geographic locations 102 may be associated with different, distinct geofencing areas. If additional geofencing are required, the routine returns to block 408. Alternatively, routine 400 terminates at block 416.

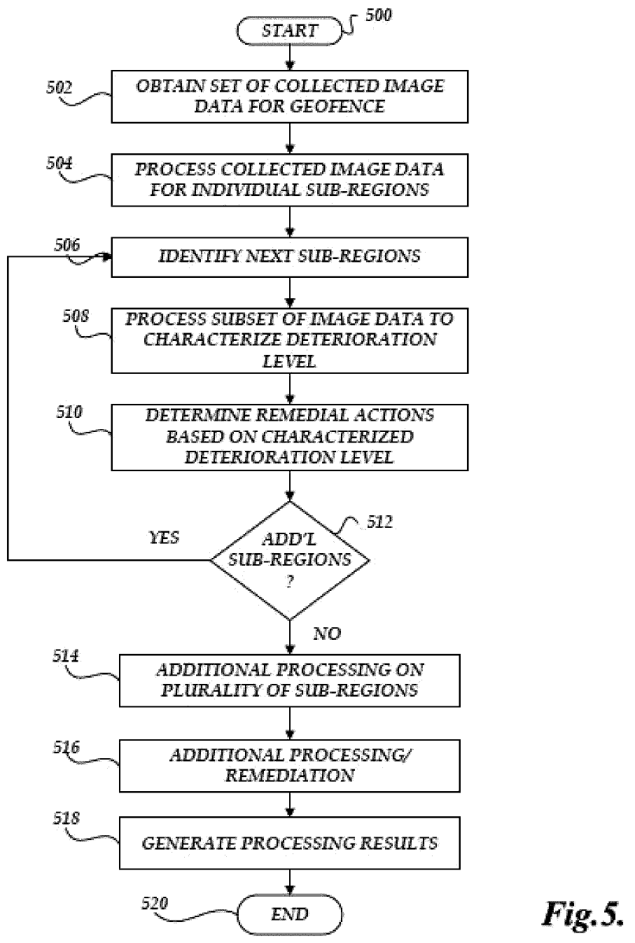

Turning now to FIG. 5, a routine 500 implemented by the location processing service 110 for processing collected image data for sub-regions will be described. At block 502, obtains the captured set of image data from the image capture device (directly or indirectly). As previously described, the resulting set of image data may be received by the location processing service 110 and stored by the location processing service. For example, the image capture device 106 may wirelessly transmit image data to the location processing service 110. In other embodiments, the image capture device 106 may collect and store the image data and transfer the collected data via wired connection or removal of a memory device (e.g., a removable mass storage device).

At block 504, the location processing service 110 can process the set of image data, which can include a plurality of image data for each individual sub-region, such as a texture map, grayscale image, color image and the like. The location processing service can also implement various extrapolations, image combination, error correction, to modify the originally collected images. In some embodiments, the location processing service may also update the flight pattern or image capture configuration information in the event that additional images may be required due to poor quality or a need to for more detailed imagery (e.g., a more detailed set of images for a potential material defect).

At block 506, the routine 500 enters into an iterative processing for individual sub-regions by selecting the next sub-region in a set of sub-regions. Illustratively, the collected image data can correspond to a sequence of sub-regions that encompass an individual geofence encompassing the area to be processed for material defects. At block 508, for each individual sub-region, the location processing service 110 can then apply one or more machine learned algorithms in which the processing image data is used as inputs. Additional inputs may also be applied. The machine learned algorithms may be configured to then generate a characterization of material defects that may be depicted in the image data. Illustratively, the characterization of material defects can correspond to hierarchical categories progressing from no significant material defects (e.g., no remediation required) to most significant material defects (e.g., complete replacement required).

As previously described, the hierarchical categories can be associated with six characterizations such that each categories relates specific processing of identifiable traits or attributes that can be captured in the set of image data. One skilled in the relevant art will appreciate, however, that various aspects of the present application may be implemented in accordance with different organization of the characterization of material defects, including different levels or categories associated with a hierarchical structure. Still further, in some embodiments, a plurality of hierarchical categories may be independently created and processed, such as for different types of material defects (e.g., hierarchical levels of cracks, hierarchical levels of porosity, etc.).

Illustratively, the training sets used to train the machine-learned algorithms, such as in a supervised learning algorithm, can be selected for purposes of distinguishing between the different hierarchical categories based on the input data, including the set of image data per sub-region. In some embodiments, a single machine learned algorithm may be configured with training sets that identify potential material defects in paved services (e.g., cracks, sunken material, porosity, etc.) and can further characterize differences in severity. For example, machine learned algorithms may be configured to determine and measure degrees of porosity. In another example, machine learned algorithms may be able to identify cracks formed in the paved surface of a sub-region and attributes of the crack including length, patterns, etc. The machine learned algorithms can further be configured to then generate the characterizations. In other embodiments, a plurality of machine learned algorithms may be configured to determine assets regarding individual categories (or groupings of categories) and associated confidence values in the characterizations.

In addition to the characterization of the sub-regions, at block 510, the location processing service 110 can further provide remediation recommendations based on, or as a function, of the characterization and image data. Illustratively, the remediation recommendations can include an identification of various remediation techniques (e.g., application of sealer, application of patching materials, partial replacement of paved materials, complete replacement of the paved materials, etc.). The remediation recommendations can further include estimates of materials required for remediation, such as volumes/weight of materials, financial costs for the estimated volumes/weights, application times (e.g., preparation and curing times), and the like. Accordingly, an individual remediation recommendation can be provided for each sub-region.

At decision block 512, the location processing service 110 determines whether additional sub-regions should be processed. For example, the location processing service 110 can use image sequence information or geographic coordinates to determine whether additional image processing is required. Additionally, in some embodiments, the location processing service 110 can further pause the processing of the image data to cause the image capture device 106 to capture additional image data based on the current processing of the sub-region, such as for error correction or to capture additional image data. If additional image data for sub-regions is still unprocessed or additional image data is captured for processing, the routine 500 returns to block 506 to process the additional image data.

Once the sub-region data is processed, at block 514, the location processing service 110 can further aggregate the remediation recommendations for individual sub-regions for a plurality of sub-regions. For example, the location image processing service can apply thresholds to a set of remediation recommendations (e.g., patching of cracks) and determine if an escalated remediation for a plurality of sub-regions (e.g., partial or full replacement) will be provided. With reference to the hierarchical categories, if a sequence of sub-regions has been categorized as indicative of level 2 individual cracks, the location processing service 110 may apply thresholding to indicate that entire set of sub-regions should be escalated to level 3 remediations as indicative of progressive material defects. Additionally, in some embodiments, the location processing service 110 can also modify or supplement the remediation estimates for materials or financial costs based on cumulative application of remediation techniques, including the amounts of materials, time for completion/curing, or financial costs based on increased quantities. For example, based on cumulative repairs, the location processing service 110 may substitute types of material used in the remediation that may be better suited for larger-scale repairs. Similarly, the location processing service 110 can further substitute types of materials or remediation techniques based on timing requirements. For example, the location processing service 110 may determine that a proposed set of remediation techniques may exceed a maximum time threshold for completion of the remediations (even if each individual remediation technique does not). Accordingly, the location processing service 110 may modify individual remediation recommendations or the set of remediation recommendations based on the time requirements.

At block 516, the location image processing service 110 can be further configured to provide additional analysis, such as compliance with regulatory requirements for markings, signage, identification of organic materials, assessment of physical structure disposed on the paved surface, etc. For example, the geographic region may be associated with local, regional or state regulations regarding markings or signage. Additionally, at block 516, the location processing service 110 can further process the material estimates and budget estimates into a multi-year assessment based on characterizations. For example, the location processing service 110 can be configured to provide prioritize remediation suggestions that identify timing and costs over a multi-year time period when remediation may occur. For example, the location processing service 110 can identify all hierarchical level 1-2 are requiring more immediate action to prevent further damage. The location processing service 110 can then process the financial and ordering remediation recommendations as occurring within the immediate time period. Additionally, hierarchical level 3 or higher categorizations may also be characterized as requiring significant remediation techniques that require additional financial expense and timing and may be spaced apart or deferred.

In other embodiments, the location processing service 110 may also query inventory systems to determine remediation material availability, such as via interfaces with inventory systems. Accordingly, the location processing service 110 can utilize the available inventory information to schedule and budget for remediation. In similar embodiments, the location processing service 110 may also query construction systems to determine crew availability, such as via interfaces with construction organizations. Accordingly, the location processing service 110 can utilize the available crew information to schedule and budget for remediation. Still further, in some embodiments, the location processing service 110 can process environmental conditions, such as ambient temperature, humidity, etc. to determine appropriate timing for implementation of remediation techniques. For example, the application of sealing materials may have limited temperature windows (e.g., a minimum temperature or a maximum temperature). Accordingly, the location processing service 110 can utilize historical environmental information to schedule remediation recommendations or adjust remediation recommendations.

Illustratively, in some embodiments, the location processing service 110 can implement or conduct any one of the additional processing in parallel to, or independent of, the characterization of material defects in the paved surface. For example, an image capture device 106 may be configured specifically to capture a set of images related to the additional processing (e.g., determination of markings/stripings in a paved surface) in manner that may or may not involve the characterization of material defects in the paved surface. For such embodiments, the location processing service 110 may only implement portions of routine 500 and further modify the described embodiments in a manner corresponding to such independent operation.

At block 518, the recommendations and characterizations may be illustratively provided as processing results, such as for user interfaces, ordering systems, project management software, and the like. Illustratively, the location processing service 110 can utilize various protocols and interfaces to communicate with other systems, such as application protocol interfaces (APIs). Routine 500 terminates at block 520.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a similarity detection system, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A similarity detection system can be or include a microprocessor, but in the alternative, the similarity detection system can be or include a controller, microcontroller, or state machine, combinations of the same, or the like configured to estimate and communicate prediction information. A similarity detection system can include electrical circuitry configured to process computer-executable instructions. Although described herein primarily with respect to digital technology, a similarity detection system may also include primarily analog components. For example, some or all of the prediction algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a similarity detection system, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An illustrative storage medium can be coupled to the similarity detection system such that the similarity detection system can read information from, and write information to, the storage medium. In the alternative, the storage medium can be integral to the similarity detection system. The similarity detection system and the storage medium can reside in an ASIC. The ASIC can reside in a user terminal. In the alternative, the similarity detection system and the storage medium can reside as discrete components in a user terminal.

Conditional language used herein, such as, among others, “can,” “could,” “might.” “may.” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising.” “including.” “having.” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for providing processing image data to identify defects in paved materials, the system comprising:
one or more computing processors and memories for executing computer-executable instructions to implement location image processing service, wherein the location image processing service is configured to:
identify a region to be processed for deterioration of paved materials;
identify at least one geofence encompassing at least a portion of the identified region to be processed;
identify an image collection flight pattern for a controllable image device drone as a function of the at least one geofence, wherein the flight pattern traverses an ordered set of sub-regions encompassing the at least one geofence;
generate a set of image data, the set of image data including a texture map, a grayscale image, and color image for the set of sub-regions;
for individual sub-regions for the set of sub-regions;
process the generated set of image data according to a machine learned algorithm to characterize material defects in paved materials, wherein the characterization corresponds to the machine learned algorithm utilizing the generated set of image data as inputs and generating an output defining a severity of material defects according to one of six defined hierarchical categories of material defects;
identify at least one remedial action for the sub-region based on the characterization; and
generate a processing result corresponding to the characterization and the identified at least one remedial action.

2. The system as recited in claim 1, wherein the location processing service is further configured to process aggregated remedial actions for a plurality of sub-regions to generate at least one additional remedial recommendation.

3. The system as recited in claim 1, wherein the location processing service is further configured to process the set of image data to conduct at least one additional processing associated with the identified region.

4. The system as recited in claim 1, wherein the identified at least one remedial action includes an automated estimation of materials associated with the identified at least one remedial action based on the characterization.

5. The system as recited in claim 1, wherein the generated set of image data corresponds to a capture of at least one top-down view and at least one angled view of individual sub-regions.

6. A method for processing image data for defects in paved areas, the method comprising:
generating a set of image data for a plurality of sub-regions of an identified geographic location, the set of image data including a texture map, a grayscale image, and color image for the plurality of sub-regions;
for individual sub-regions, processing the generated set of image data according to a machine learned algorithm to define material defects in paved materials, wherein the definition of material defects corresponds to the machine learned algorithm utilizing the generated set of image data as inputs and generating an output defining a severity of material defects according to hierarchical categories of material defects;
identify at least one remedial action for the sub-region based on the definition of material defects; and
generate a processing result corresponding to the definition of material defects and the identified at least one remedial action.

7. The method as recited in claim 6, further comprising processing aggregated remedial actions for a plurality of sub-regions to generate at least one additional remedial recommendation.

8. The method as recited in claim 7, wherein processing the aggregated remedial actions include applying a threshold associated with individual remedial actions for a plurality of sub-regions and defining at least one additional remedial action based on exceeding the applied threshold.

9. The method as recited in claim 6, further comprising processing the set of image data to conduct at least one additional processing associated with the identified geographic location.

10. The method as recited in claim 9, wherein further comprising processing the set of image data to conduct at least one additional processing includes identifying organic material in at least one sub-region.

11. The method as recited in claim 9, wherein further comprising processing the set of image data to conduct at least one additional processing characterizing compliance with at least one regulation.

12. The method as recited in claim 6, wherein the characterization corresponds to the machine learned algorithm utilizing the generated set of image data as inputs and generating an output defining a severity of material defects according to one of six hierarchical categories of material defects.

13. The method as recited in claim 6, wherein processing the generated set of image data according to a machine learned algorithm to characterize material defects in paved materials includes processing the generated set of image data according to a plurality of machine learned algorithms to characterize material defects in paved materials, wherein the plurality of machine learned algorithms corresponds to individual hierarchical categories.

14. The method as recited in claim 6, wherein the identified at least one remedial action includes an automated estimation of materials associated with the identified at least one remedial action based on the characterization.

15. The method as recited in claim 14, wherein the automated estimation of materials includes at least one of an amount of material or an estimated financial cost.

16. A method for identifying defects in paved areas, the method comprising:
obtaining a set of sensor data for a plurality of sub-regions of an identified geographic location;
for individual sub-regions, processing the obtained set of sensor data according to a machine learned algorithm to characterize material defects in paved materials, wherein the characterization corresponds to the machine learned algorithm utilizing the generated set of sensor data as inputs and generating an output defining a severity of material defects according to hierarchical categories of material defects;
identify at least one remedial action for the sub-region based on the characterization; and
generate a processing result corresponding to the characterization and an identified remedial action based on the characterization.

17. The method as recited in claim 16, further comprising processing aggregated remedial actions for a plurality of sub-regions to generate at least one additional remedial recommendation.

18. The method as recited in claim 16, further comprising processing the set of sensor data to conduct at least one additional processing associated with the identified geographic location.

19. The method as recited in claim 18, wherein the at least one additional processing includes generating a multi-year budget estimate.

20. The method as recited in claim 16, wherein the identified at least one remedial action includes an automated estimation of materials associated with the identified at least one remedial action based on the characterization.

21. The method as recited in claim 20, wherein the automated estimation includes information from at least one external resource.
